(19) United States
(12) Patent Application Publication
(10) Pub. No.: US 2014/0289092 A1
(43) Pub. Date: Sep. 25, 2014

(54) CARBON BOND FINANCIAL SYSTEM AND METHOD FOR REDUCING GREEN HOUSE GASES AND CARBON FOOTPRINT

(71) Applicant: Gary Keir, New York, NY (US)

(72) Inventor: Gary Keir, New York, NY (US)

(21) Appl. No.: 14/218,127

(22) Filed: Mar. 18, 2014

Related U.S. Application Data
(60) Provisional application No. 61/803,160, filed on Mar. 19, 2013.

(51) Int. Cl. G06Q 40/04

(52) U.S. Cl. CPC G06Q 40/04
USPC 705/37

(57) ABSTRACT

A computer implemented method for creating and selling carbon bonds which allow bond purchasers to offset and reduce their respective carbon footprint, by establishing one or more carbon bonds by a selling entity; registering the carbon bonds in a purchaser database on a networked server via a web-based platform; registering bond purchasers in the purchaser database on the networked server; accessing the registered carbon bonds by the bond purchasers via a first communication interface on the web-based platform and comparing the bonds; based on the comparison the bond purchaser purchases the carbon bond and transfers purchasing funds to the selling entity creating a loan pool of funds; registering borrowers in a borrower's database on the networked server who need developing funds for energy efficient and renewable energy projects; comparing projects by the selling entity via a second communication interface on the web-based platform; based on the comparison the selling entity selects a project and lends a portion of the loan pool of funds to the selected borrower for developing funds, wherein the selected borrower repays the selling entity principal plus interest wherein turn the selling entity repays the bond purchaser principal plus interest.

This application claims the benefit of U.S. provisional application No. 61/803,160 filed Mar. 19, 2013, which is incorporated herein in its entirety by reference.

### FIELD OF THE INVENTION

The present invention relates to a financial system and method for providing financial benefits to individuals and businesses while reducing green house gases. More particularly, the invention provides a process whereby an individual invests a fee equivalent to their carbon emissions resulting from their activities and the funds invested are used to fund renewable energy projects. The process also provides tracking of compliance with government or third party Green House Gas (“GHG”) emission requirements.

### BACKGROUND OF THE INVENTION

Most Americans and citizens of the world are at least somewhat worried about global warming. Over the past century temperatures have been going up, ice sheets are melting, sea levels are changing, patterns of rainfall and drought are changing, heat waves are worsening and the oceans are acidifying. Approximately 97% of climate scientists, based on well established evidence, have concluded that human-caused climate change is happening.

A few decades ago, chlorofluorocarbons were common in refrigerators, air-conditioners, cans of hair spray and deodorant. It is now known that these chemicals break down the ozone layer, a blanket of gas that protects the world from devastating levels of ultraviolet radiation. The world has recognized the danger of these chemicals and their use is being phased out. Global warming, a by-product of the fossil-fuel industry, has been harder to understand, not only by scientists but also by individuals.

The science of global warming is just evolving and many questions have not yet been answered. What is clear though is that the potential consequences of planetary warming are dire. Severe food shortages may be possible as warming makes it harder to grow crops; accelerating rise of the sea may indundate coastlines too rapidly for humans too adjust; and extreme heat waves, droughts and floods may lead to extinction of plants and animals. These are all risks which if the global population doesn't act on to avoid these scenarios can become all too real. Scientists argue about the urgency of this problem but agree that the fate of future generations is being determined by emission levels now. By lowering green house gas emissions the risk of these catastrophic events happening is lessened. With the potential risks being so severe all citizens of the world must take notice and participate to reduce greenhouse gases and offset their respective carbon footprint to keep our ever changing environment in balance.

In today's world it is difficult for an individual who is concerned about their carbon footprint and who is without solar or wind resources and without the opportunity for energy efficiency upgrades to be involved in reducing green house gases. Many renters, co-op and condominium owners, and people and businesses that are on low floors or in the shade fall in this category. Businesses can be involved through Renewable Energy Credits. Large investors can take advantage of the tax equity. It is currently very difficult for individuals and small investors to participate in energy efficiency and renewable energy projects that are not directly associated with their own property. The invention system and method gives the general public the opportunity to be financially involved in the responsibility, risk and the rewards of reducing green house gases and their own carbon footprint.

The system and process is designed for all members of the general public. It combines the process of paying a fee for carbon emissions resulting from their activities and the opportunity to invest in energy efficiency and renewable energy projects being developed by parties other than themselves.

The invention provides that an entity sells a “Carbon Bond” to members of the general public who desire or need to minimize their carbon footprint. The Carbon Bond is a financial instrument which is priced at the current price of one ton of carbon dioxide or carbon dioxide equivalent, such as methane, nitrous oxide, chlorofluorocarbons and green house gases. The entity then uses these funds to invest in energy efficiency projects and or renewable energy projects. The developers of these projects will then repay the entity the principle plus an amount of interest on that principle. The entity will then pay the holder of the “Carbon Bond” their principle plus an amount of interest.

The entity selling the Carbon Bond is a bank, savings and loan, or a mutual fund, as well as solar real estate investment trusts (S-REITs), public solar ownership funds (‘yieldcos’), crowd-funding entities, credit unions, utilities, brokerage houses and others.

Both U.S. Pat. No. 7,343,341 to Sandor et al., U.S. Pat. No. 7,529,705 to Bartels et al. and U.S. Patent Publication 2011/0087578 to Finck et al. (assigned to Bank of New York) all disclose trading systems involving carbon credits. However, none of these references specifically disclose the invention use of proceeds to fund renewable energy projects

In general, the invention provides an advantage over known methods by providing a web-based financial process for purchasing carbon bonds where the proceeds are used to provide funds for renewable energy projects. In particular an individual (or company) purchases a carbon bond from a selling entity (such as a bank, savings and loan or a mutual fund) who in turn invests these funds in energy efficiency projects and/or renewable energy projects. The developers of these projects repay the entity principal plus interest. The selling entity then pays the holder of the carbon bond back their principal plus interest. The carbon bond is priced at the current price of one ton of carbon dioxide or carbon dioxide equivalent. While entities may have green practices as part of their business protocols, there are no green financial products currently being offered to the consuming public.

An advantage of the invention is that it provides the general public an opportunity to take financial responsibility for Green House Gases resulting from their activities.

Another advantage of the inventions is that it allows any size investor to easily participate in the funding of energy efficiency and renewable energy projects.

Yet another advantage of the invention is that unlike Renewable Energy Credits, Carbon Tax, and Cap and Trade the purchaser of the “Carbon Bonds” receive a financial return in addition to paying a fee for their carbon emissions.

Still another advantage of the invention is in the pooling of funds from the Carbon Bond investments and distributing them to many projects which minimizes risk to the bond holders.

Another advantage of the invention is for the selling entities, such as banks, to offer a green financial product.

Another advantage of the invention is in the provision of the carbon bonds which changes the payoffs compared to other greenhouse gas reduction strategies such as Cap and Trade, Renewable Energy Credits and a Carbon Tax.

Another advantage of the carbon bond of the invention is in the stability in the price of carbon. The carbon bond is not subject to the volatility of the carbon markets.

Still another advantage of the invention process is to increase the money supply for renewable energy and energy efficient projects which would reduce the cost for such projects. A further option includes that a portion of this money could be held in a loan loss reserve or other credit enhancements for risker loans such as efficiency for multi-family affordable housing.

Still another advantage of the carbon bonds of the invention provides a means for a company which plans on making a major efficiency or renewable energy improvement project years down the line but wishes to show environmental responsibility in the current fiscal year, could purchase the carbon bonds now and then use the capital and interest earned to finance the project in a future year.

Another advantage of the carbon bonds of the invention is in fulfilling the need for any size or type of business to demonstrate sustainability. High sustainable businesses are more profitable than low sustainable businesses. More and more companies are filing sustainability reports.

Another advantage of the carbon bonds is to relieve the feeling of helplessness that many fee when facing the problem of climate change.

### SUMMARY OF THE INVENTION

In the present invention, these purposes, as well as others which will be apparent, are achieved generally by a web-based financial system for purchasing carbon bonds and reducing and offsetting green house gases and the carbon footprint. The financial system is implemented by a computer or personal digital assistant for creating and selling carbon bonds. The system provides a web-based platform which is accessed by a bond purchaser and borrower at separate communication interfaces on a networked server.

The bond purchaser purchases carbon bonds which have been registered in the purchaser database on the networked server, by the selling entity. The purchasing funds are transferred to the selling entity creating a loan pool of funds.

The borrower registers in a borrower's database on the networked server. These borrowers are seeking developing funds for energy efficient and renewable energy projects. The selling entity compares these projects and selects a project to lend a portion of the loan pool of funds to the selected borrower for their developing funds. The selected borrower repays the selling entity principal plus interest, wherein the selling entity repays the bond purchaser principal plus interest.

The system includes a networked server having a first communication interface on the web-based platform which is accessed by the bond purchaser via the internet; a processor; and purchaser data storage. The purchaser data storage includes information such as the name of the purchasing entity of the Carbon Bond, date of the carbon bond, tons of carbon, an identifier, and the price of carbon on the date of purchase. The funds from the sale of Carbon Bonds are used to finance energy efficient and renewable energy projects by a borrower who is selected by the selling entity. The bond purchaser can name a beneficiary for each carbon bond which can also be stored in the purchaser data storage.

A second communication interface on the networked server is provided for the borrower via the internet, and the borrower data storage includes the name of the borrower, project details and terms of the financial instrument, such as the length of time, interest rate and other payback provisions. The bond proceeds are used by the selling entity to fund energy efficient and renewable energy projects which offset and reduce green house gaseous and the overall carbon footprint on the planet.

The system also provides a means for calculating the interest to be paid by the borrowing entity to the selling entity and the interest paid by the selling entity to the bond purchaser.

The system also provides a means to create certification for green house gas emission offsets.

The invention also includes a web-based platform method for reducing green house gases comprising the steps of a networked server having separate communication interfaces with a bond purchaser and a borrower via the internet; a processor and data storage. The bond purchaser data storage includes information the name of the purchasing entity of the carbon bond, date of carbon bond, tons of carbon, an identifier, and the price of carbon on the date of purchase. The borrower data storage includes the name of the borrower, project details and terms of financial instrument. The bond purchaser purchases carbon bonds based on the carbon dioxide usage of the purchaser. The borrowers energy efficiency and renewable energy projects are financed using funds from the sale of carbon bonds. The interest paid by the borrowing entity, and paid to the bond purchaser, are calculated by the system. The invention also provides a method to track Green House Gas emission offsets to satisfy compliance with government agencies or certification bodies.

Other objects, features and advantages of the present invention will be apparent when the detailed description of the preferred embodiments of the invention are considered with reference to the drawings, which should be construed in an illustrative and not limiting sense.

### BRIEF DESCRIPTION OF THE DRAWINGS

FIG. 1 is a schematic illustration of the general system and method according to the invention;

FIG. 2 is a schematic illustration of an alternate embodiment of the invention for certification for Green House Gas Emission (GHG) offsets.

### DETAILED DESCRIPTION OF THE INVENTION

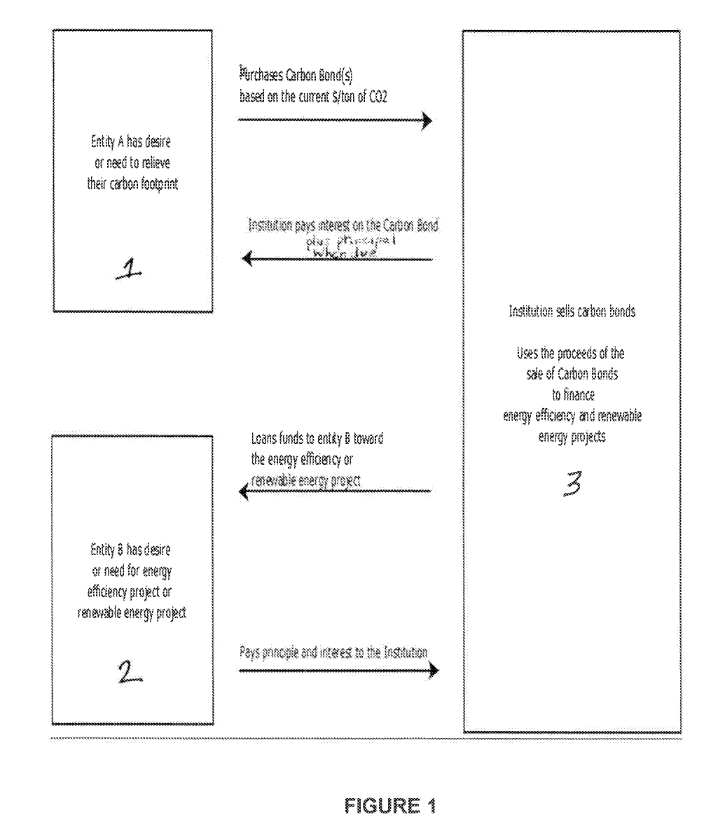

In accordance with the present invention, and as illustrated in FIG. 1, a computer implemented system to create carbon dioxide equivalent offsets is provided.

As shown in FIG. 1, Entity A 1, has a desire or need to relieve their carbon footprint. Entity B 2, has a desire or need for an energy efficiency project or renewable energy project. Entity 3 sells the Carbon Bonds to Entity A and uses the proceeds of the sale of the Carbon Bonds to finance the energy efficiency and renewable energy projects of Entity B.

Entity A can be a company, agency, or individual that purchases these Carbon Bonds to offset the carbon dioxide emissions from that entity's activities. The entity may purchase these Carbon Bonds to comply with governmental regulations, voluntary certifications, or a simple desire to reduce carbon dioxide emissions. The bonds are sold by a ton of carbon dioxide based on the current price of CO2E specified by agencies, markets, or the issuing institution.

The funds collected from these bonds are used to finance energy efficiency and renewable energy projects. The scale of these projects range from small home efficiency projects such as weather sealing to retrofits to large capital renewable energy projects. The lending form could be a home equity loan.

The funds can also be used to finance Energy Service Contracts or any financial instrument that provides capital for energy efficiency or renewable energy. An interest rate would be charged for these financing instruments to be paid over a specified time period. A portion of the proceeds from the interest rate charged on the financing instruments would then be paid to the holder of the Carbon Bond. After a specified amount of time, the holder of the carbon bond can request the return of the purchasing amount and retire the carbon bond.

The basic premise of the Carbon Bond is to combine the practice of offsetting carbon Dioxide equivalent (CO2E) emissions and Impact Investing in energy efficiency and renewable energy projects. Some of the methods currently used to offset CO2E emissions are Renewable Energy Credits, Cap and Trade on CO2E emissions, and a tax on CO2 emissions. These methods constitute a monetary expense or a penalty on the entity whose activity results in CO2E emissions. Once the expense or penalty is paid there is no monetary return on that amount. The Carbon Bond provides a vehicle to offset the CO2E emissions by a monetary payment that will eventually be paid back, an Impact Investment, to the entity whose activities result in CO2E emissions. The pool of money collected by the purchase of Carbon Bonds would then be available to finance Energy Efficiency and renewable energy projects. In addition the Carbon Bond is scalable from large institutions to the consumer level for both the purchase of the Carbon Bond and access to the capital for financing energy efficiency and renewable energy projects.

The Carbon Bond differs from other carbon reducing strategies. Current Carbon Financial Instruments (CFIs), such as Cap and Trade, require a credit to that is created for an entity whose carbon emissions are below a limit set forth by government or certification organizations. These credits are then traded to entities that exceed that allowance limit. A carbon tax would simply tax the carbon emissions an entity's activities would produce. The Carbon Bond does not require any emissions credits to exist. An entity that needs to comply with government or an organizations certification requirements or simply desires to reduce carbon emissions can purchase a Carbon Bond that is an incremental investment in energy efficiency and renewable energy.

The invention provides a computer implemented method for creating and selling carbon bonds which allow bond purchasers to offset and reduce their respective carbon footprint. The steps of the method include establishing one or more carbon bonds by a selling entity and registering the carbon bonds in a purchaser database on a networked server via a web-based platform.

Bond purchasers are registered in the purchaser database on the networked server, who can then access the registered carbon bonds via a first communication interface on the web-based platform and comparing the bonds.

The bonds are financial instruments similar to a certificate of deposit (CD) or an E bond. Carbon bonds are a term deposit which can be 90 days, 1 year, 5 year, 10 year etc.

The purchaser compares the term of the bond, the purchase price and rate of return of the registered carbon bonds to decide which bond to purchase. Based on the comparison the bond purchaser purchases the carbon bond and transfers purchasing funds to the selling entity creating a loan pool of funds.

Purchasing a carbon bond requires the company or individual to take responsibility for their greenhouse gas emission. To determine this responsibility the invention looks at the amount of emissions in tons of carbon dioxide. The average American person produces 18 tons of carbon dioxide per year. This number is then multiplied by the price of carbon dioxide. Currently the U.S. government estimates the price of carbon dioxide at $33/ton. Thus, the average person could purchase a carbon bond for $594/year. This money is pooled together and used to finance renewable energy and energy efficient project. The interest on the financing is then used to pay the interest on the term deposit. In the end the carbon bond holder gets their money back with interest. For large companies and investment trust might be used instead of a trust. In any case, by purchasing a carbon bond individuals and companies are offsetting their carbon footprint and to help finance projects designed to reduce greenhouse gases.

The carbon bonds are contemplated to be par value, where par value is the price of one ton of carbon dioxide or carbon dioxide equivalent including methane, nitrous oxide, chlorofluorocarbons and green house gases. While this is preferred, the selling entity may decide to sell the carbon bonds at a discount or a premium based on interest rate changes.

Borrowers who need developing funds for energy efficient and renewable energy projects are registered in a borrower's database on the networked server.

The selling entity compares borrower projects via a second communication interface on said web-based platform. Based on the comparison the selling entity selects a project and lends a portion of the loan pool of funds to the selected borrower as their developing funds.

The selected borrower repays the selling entity principal plus interest wherein turn said selling entity repays said bond purchaser principal plus interest. Only the selling entity has access to both the purchaser database and the borrower's database. Known bond trading practices are within the scope of the invention and are included herein.

The borrower's energy efficient and renewable energy projects are any projects that will reduce the carbon footprint or offset carbon dioxide emission.

The price of said carbon bond is equal to the market price of one ton of carbon dioxide or carbon dioxide equivalent, such as methane, nitrous oxide, chlorofluorocarbons and green house gases. The price of carbon dioxide is specified by agencies, markets or the selling entity.

The bond purchaser can be a company, agency or individual that purchases carbon bonds to offset the carbon dioxide emissions from their own activities. It is anyone who desires to help reduce and offset greenhouse gases and reduce the carbon footprint of the globe.

The bond purchaser data storage includes information such as the name of the purchasing entity of the carbon bond, date of the carbon bond, tons of carbon, an identifier, and the price of carbon on the date of purchase. The funds from the sale of carbon bonds are used to finance energy efficient and renewable energy projects by a borrower who is selected by the selling entity. The bond purchaser can name a beneficiary for each carbon bond which can also be stored in the purchaser data storage.

A Bond purchaser may buy carbon bonds to comply with governmental regulations and voluntary certifications.

The bond purchaser is taking responsibility for their carbon dioxide emissions by purchasing carbon bonds that are then used to fund energy efficient and renewable energy projects.

The selling entity is a bank, savings and loan, mutual fund, solar real estate investment trusts or public solar ownership funds, crowd-funding entities, credit unions, utilities, and brokerage houses.

The carbon bond has a set maturity date, and upon the maturity date the carbon bond is retired and the information stored in the purchaser database.

The carbon bond is used to satisfy compliance with government agencies or certification bodies.

Proof of purchase of carbon bonds is stored in the purchaser database and can be sent in electronic format.

The amount of interest the carbon bond generates is on a specified periodic time table calculated and recorded in the purchaser database.

The borrowing entity project description, an identifier and the terms of the financial loan instrument is recorded in the borrower database.

The amount of interest from the financial loan instrument is calculated and recorded in the borrower database.

The invention also provides a web-based platform method for reducing green house gases comprising the steps of a networked server having a first communication interface with a bond purchaser via the internet, a processor and purchaser data storage.

The purchaser data storage contains information including the name of the purchasing entity of the carbon bond, date of carbon bond, tons of carbon, an identifier, and the price of carbon on the date of purchase and beneficiary, if any.

The networked server also has a second communication interface with a borrower via the internet, and a borrower data storage. The borrower data storage contains information including the name of said borrower, project details and terms of the financial loan instrument.

Carbon bonds are purchased by said bond purchaser based on the carbon dioxide usage of the purchaser.

Borrower's energy efficiency and renewable energy projects are financed using funds from the sale of carbon bonds; and interest to be paid by the borrower is calculated and interest paid to the bond purchaser is calculated.

The carbon bond is used to satisfy compliance with government agencies or certification bodies.

The selling entity of the carbon bonds in the web-based platform is a bank, savings and loan, mutual fund, solar real estate investment trusts or public solar ownership funds, crowd-funding entities, credit unions, utilities, and brokerage houses. Only the selling entity has access to both the purchaser data storage and the borrower's data storage.

The web-based platform includes a computer processor, memory device, a network connection and at least one user interface. The information for a purchase of a carbon bond is entered through a user interface. The user interface is connected via the network to a memory device that contains a database. The information is recorded in a purchaser database. This information includes the name of the purchasing entity of the carbon bond, date, tons of carbon, an identifier, the price of carbon on that date, and beneficiary, if any. The carbon bond is created in this process and does not originate from another source. The carbon bond can also be used to satisfy compliance with government agencies or certification bodies. For compliance with a government agency or a certification body, proof of purchase of these carbon bonds is stored in the database and proof can be sent in electronic format or printed.

The system calculates the amount of interest the carbon bond would generate on a specified periodic time table. A record of the interest amount to be paid on the carbon bond is then recorded in the database.

The selling entity/issuer of the carbon bond may or may not set a maturity date on the carbon bond. The maturity date is stored in the database and entered at the time of purchase or later through the user interface via the network connection. Upon maturity the computer retires the carbon bond and store the information in the database.

A specified percentage of the funds from the sale of Carbon Bonds is available to finance energy efficiency and renewable energy projects. The amount of funds collected by these Carbon Bonds is pooled together and is available to provide capital for energy efficiency and renewable energy projects.

The information for an entity to borrow funds to finance energy efficiency or renewable energy projects is entered through a user interface. The user interface is connected via the network to a memory device that contains a database. The information is recorded in the database. This information includes the name of the borrowing entity of the funds, date, project description, an identifier, and the terms of the financial instrument.

The system calculates the amount of interest the financial instrument generates on a specified periodic time table. A record of the interest amount to be paid by the borrowing entity is then recorded in the database. Payments to service the interest and principle of the financial instrument is entered either through a user interface or an electronic fund transfer via the network and recorded in the database.

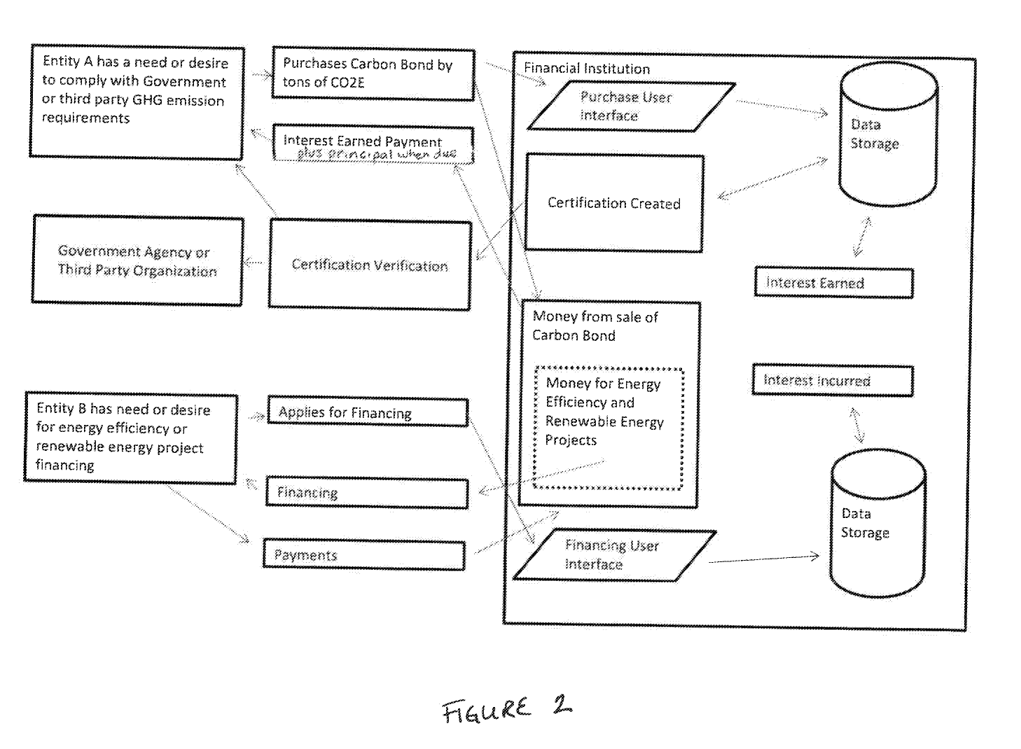

As illustrated in FIG. 2, an alternate embodiment of the invention, a method and system for certification for Green House Gas Emission (GHG) offsets is provided. A computer implemented system to create Certification for Green House Gas Emission (GHG) offsets is illustrated. An entity such as a company, agency, or individual purchases Carbon Bonds to offset the GHG from that entity's activities. The entity purchases these Carbon Bonds to comply with governmental regulations, voluntary certifications, or a simple desire to reduce carbon dioxide emissions. The bonds are sold by a ton of CO2E based on the current price of CO2E specified by agencies, markets, or the issuing institution. The funds collected from these bonds are used to finance energy efficiency and renewable energy projects.

The scale of these projects can range from small home efficiency projects such as weather sealing to retrofits to large capital renewable energy projects. The form could be as simple as a home equity loan. It could also be used to finance Energy Service Contracts or any financial instrument that could provide capital for energy efficiency or renewable energy. An interest rate would be charged for these financing instruments to be paid over a specified time period. A portion of the proceeds from the interest rate charged on the financing instruments would then be paid to the holder of the Carbon Bond. After a specified amount of time, the holder of the carbon bond could request the return of the purchasing amount and retire the carbon bond.

The basic premise of the Carbon Bond is to combine the practice of financially offsetting GHG emissions and Impact Investing in energy efficiency and renewable energy projects. The Carbon Bond serves as a compliance instrument for an entity whose GHG emissions exceed a GHG emission limit set forth by law. The Carbon bond would also serve as a compliance instrument for an entity whose GHG emissions exceed GHG emission limit set forth by third party certification requirements. The funds collected by the sale of Carbon Bonds would be used as an impact investment in energy efficiency and renewable energy projects.

Some of the methods currently used to offset GHG emissions are Renewable Energy Credits, Cap and Trade on GHG emissions, and a tax on GHG emissions. These methods constitute a monetary expense or a penalty on the entity whose activity results in GHG emissions. Once the expense, penalty, or tax is paid there is no monetary return on that amount. The Carbon Bond provides compliance to GHG emissions limits set by government regulations or third party certification requirements by a monetary payment that will eventually be paid back, an Impact Investment, to the entity whose activities result in GHG emissions. The pool of money collected by the purchase of Carbon Bonds would then be available to finance Energy Efficiency and renewable energy projects.

Current Carbon Financial Instruments (CFIs), such as Cap and Trade and Renewable Energy Credits, require a credit that is created for an entity whose carbon emissions are below a limit set forth by government or certification organizations. These credits are then traded to entities that exceed that allowance limit. The Carbon Bond does not require any emissions credits to exist. An entity whose GHG emissions levels exceed those limits set by government regulations would purchase Carbon Bonds to comply with those regulations. An entity whose GHG emissions levels exceed those set forth by a third party organization would purchase Carbon Bonds to meet the third party's requirements. An entity who simply desires to reduce carbon emissions can purchase a Carbon Bond. A certification for GHG reduction would be generated and then issued to that entity.

The Carbon Bond is scalable from large institutions to the consumer level for both the purchase of the Carbon Bond and access to the capital for financing energy efficiency and renewable energy projects.

The method of the Carbon Bond comprises a computer processor, memory device, a network connection and at least one user interface. The information for a purchase of a Carbon Bond is entered through a user interface. The user interface is connected via the network to a memory device that contains a database. The information is recorded in the database. This information includes the name of the purchasing entity of the Carbon Bond, date, location, tons of carbon, an identifier, and the price of carbon on that date. The Carbon Bond is created in this process and does not originate from another source.

The computer system creates a certification for that carbon bond and it would include the name of the entity, date, location, tons of CO2E purchased, and a unique certification identifying number generated by the computer.

The certification by the computer verifies compliance with a government agency or a certification body as proof of GHG offsets by the purchase of these Carbon Bonds. A physical document can be created on a printer connected via the network to the database or certification in an electronic format such as an email could be created and sent via the network from information stored in the database. A user interface to extract information from the database via the network could be created to display information about Carbon Bond purchases such as tons of GHG offsets, interest earned, maturity, and payments.

The system calculates the amount of interest the carbon bond would generate on a specified periodic time table. A record of the interest amount to be paid on the carbon bond is then be recorded in the database.

The issuer of the Carbon Bond may or may not set a maturity date on the Carbon Bond. The maturity date would be stored in the database and entered at the time of purchase or later through the user interface via the network connection.

Upon maturity the system retires the Carbon Bond and stores the information in the database.

The funds from the sale of Carbon Bonds are available to finance energy efficiency and renewable energy projects. The amount of funds collected by these Carbon Bonds is pooled together and is available to provide capital for energy efficiency and renewable energy projects.

The information for an entity to borrow funds to finance energy efficiency or renewable energy projects is entered through a user interface. The user interface is connected via the network to a memory device that contains a database. The information is recorded in the database. This information includes the name of the borrowing entity of the funds, date, location, project description, estimated GHG savings, an identifier, and the terms of the financial instrument.

The system calculates the amount of interest the financial instrument would generate on a specified periodic time table. A record of the interest amount to be paid by the borrowing entity is then be recorded in the database.

Payments to service the interest and principle of the financial instrument is entered either through a user interface or and electronic fund transfer and via the network this entry is recorded in the database.

A user interface to extract information from the database via the network is created to display the energy efficiency and renewable energy projects and information related to the project such as GHG estimated savings, interest earned, location, and maturity.

The foregoing description of various and preferred embodiments of the present invention has been provided for purposes of illustration only, and it is understood that numerous modifications, variations and alterations may be made without departing from the scope and spirit of the invention as set forth in the following claims.

What is claimed is:

1. A computer implemented method for creating and selling carbon bonds which allow bond purchasers to offset and reduce their respective carbon footprint, the method comprising:
establishing one or more carbon bonds by a selling entity;
registering said carbon bonds in a purchaser database on a networked server via a web-based platform;
registering bond purchasers in said purchaser database on said networked server;
accessing the registered carbon bonds by said bond purchasers via a first communication interface on said web-based platform and comparing said bonds;
based on the comparison the bond purchaser purchases the carbon bond and transfers purchasing funds to the selling entity creating a loan pool of funds;
registering borrowers in a borrower's database on said networked server who need developing funds for energy efficient and renewable energy projects;
comparing projects by said selling entity via a second communication interface on said web-based platform;
based on the comparison the selling entity selects a project and lends a portion of the loan pool of funds to the selected borrower for said developing funds, wherein said selected borrower repays the selling entity principal plus interest wherein turn said selling entity repays said bond purchaser principal plus interest.

2. The method of claim 1, wherein said selling entity has access to both said purchaser database and said borrower's database.

3. The method of claim 1, wherein said energy efficient and renewable energy projects are any projects that will reduce the carbon footprint or offset carbon dioxide emission.

4. The method of claim 1, wherein the price of said carbon bond is equal to the market price of one ton of carbon dioxide or carbon dioxide equivalent including methane, nitrous oxide, chlorofluorocarbons and green house gases.

5. The method of claim 4, wherein the price of carbon dioxide is specified by agencies, markets or the selling entity.

6. The method of claim 1, wherein the bond purchaser is a company, agency or individual that purchases carbon bonds to offset the carbon dioxide emissions from their activities.

7. The method of claim 1, wherein said bond purchaser purchases carbon bonds to comply with governmental regulations.

8. The method of claim 1, wherein said bond purchaser purchases carbon bonds to comply with voluntary certifications.

9. The method of claim 1, wherein said bond purchaser takes responsibility for their carbon dioxide emissions by purchasing said carbon bond that is then used to fund energy efficient and renewable energy projects.

10. The method of claim 1, wherein said selling entity is a bank, savings and loan, mutual fund, solar real estate investment trusts or public solar ownership funds, crowd-funding entities, credit unions, utilities, and brokerage houses.

11. The method of claim 1, wherein said carbon bond has a set maturity date, and upon said maturity date the carbon bond is retired and the information stored in said purchaser database.

12. The method of claim 1, wherein the carbon bond is used to satisfy compliance with government agencies or certification bodies.

13. The method of claim 12, wherein proof of purchase of carbon bonds is stored in the purchaser database and can be sent in electronic format.

14. The method of claim 1, wherein the amount of interest the carbon bond generates is on a specified periodic time table calculated and recorded in the purchaser database.

15. The method of claim 1, wherein the borrowing entity project description, an identifier and the terms of the financial loan instrument is recorded in the borrower database.

16. The method of claim 13, wherein the amount of interest from the financial loan instrument is calculated and recorded in the borrower database.

17. A web-based platform method for reducing green house gases comprising the steps of:
a networked server having a first communication interface with a bond purchaser via the internet, a processor and purchaser data storage; wherein said purchaser data storage contains information including the name of the purchasing entity of the carbon bond, date of carbon bond, tons of carbon, an identifier, and the price of carbon on the date of purchase;
said networked server has a second communication interface with a borrower via the internet, and a borrower data storage; wherein said borrower data storage contains information including the name of said borrower, project details and terms of the financial loan instrument;
purchasing a carbon bond by said bond purchaser based on the carbon dioxide usage of the purchaser;
financing said borrowers energy efficiency and renewable energy projects using funds from the sale of carbon bonds; and
calculating the interest paid by the borrowing entity on the financial loan instrument and calculating interest paid to the bond purchaser.

18. The method according to claim 17, wherein the carbon bond is used to satisfy compliance with government agencies or certification bodies.

19. The method according to claim 1, wherein a selling entity of the carbon bonds is a bank, savings and loan, mutual fund, solar real estate investment trusts or public solar ownership funds, crowd-funding entities, credit unions, utilities, and brokerage houses.

20. The method of claim 19, wherein said selling entity has access to both said purchaser data storage and said borrower's data storage.
